(19) United States
(12) Patent Application Publication
(10) Pub. No.: US 2016/0129969 A1
(43) Pub. Date: May 12, 2016

(54) SPEED CONTROL APPARATUS AND METHOD FOR BICYCLE

(71) Applicant: Chiun Mai Communication Systems, Inc., New Taipei (TW)

(72) Inventor: YU-CHEN CHEN, New Taipei (TW)

(21) Appl. No.: 14/681,866

(22) Filed: Apr. 8, 2015

(30) Foreign Application Priority Data
Nov. 10, 2014 (CN) 201410627086.0

(51) Int. Cl. B62M 6/50; B62M 6/80

(52) U.S. Cl. CPC B62M 6/50; B62M 6/80

(57) ABSTRACT

A speed control apparatus for a bicycle includes a power-assisted unit, a control unit, and at least one of a gravity sensor (G-sensor) and an electromotive force generating unit. The power-assisted unit provides extra power to the bicycle. The G-sensor senses a slope of a road. The electromotive force generating unit produces electromotive force in response to riding of the bicycle. The control unit activates or deactivates the power-assisted unit according to the electromotive force or the slope of the road or both.

### FIELD

The subject matter herein generally relates to speed control systems, and more particularly relates to a control apparatus and a control method for changing a speed of a bicycle or a hybrid vehicle.

### BACKGROUND

Conventionally, a speed change assembly is employed in a bicycle. For example, a pressure sensor of the speed change assembly is mounted at a pedal of the bicycle to sense a force applied to the pedal, thereby controlling a gear of the bicycle.

### BRIEF DESCRIPTION OF THE DRAWINGS

Implementations of the present technology will now be described, by way of example only, with reference to the attached figures.

FIG. 1 is a block diagram of a speed control apparatus for a bicycle, according to an exemplary embodiment.

FIG. 2 is a flowchart of one embodiment of a speed control method for the bicycle using the speed control apparatus of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a speed control apparatus and a speed control method for a bicycle.

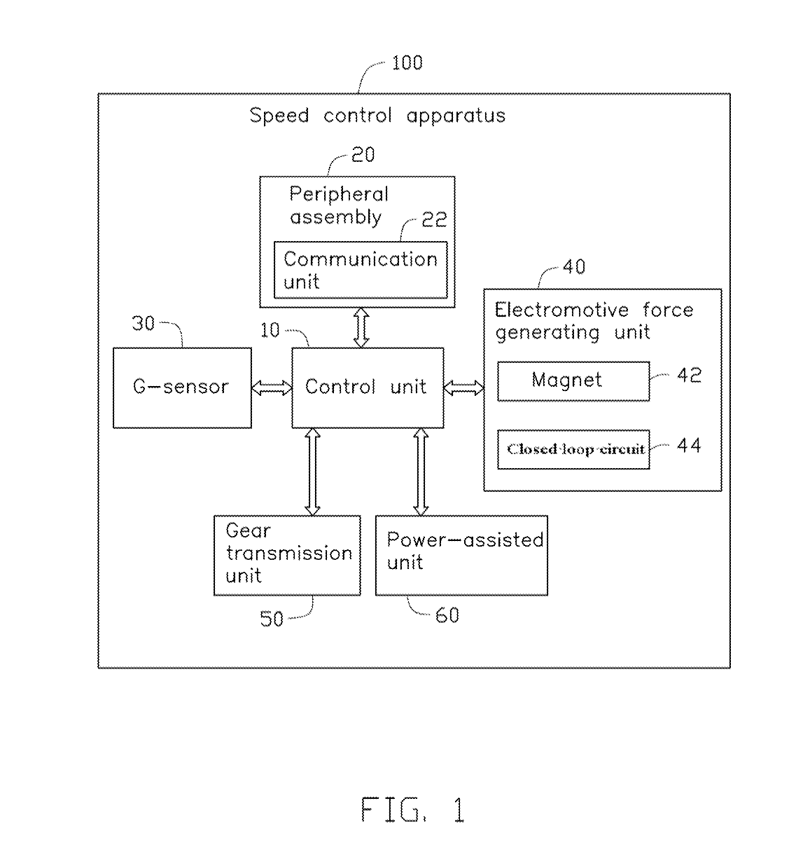

FIG. 1 illustrates an embodiment of a speed control apparatus 100, according to an exemplary embodiment. The speed control apparatus 100 is employed in a bicycle having a pedal for changing a speed of the bicycle. In other embodiments, the bicycle can also be electric or hybrid vehicles.

The speed control apparatus 100 includes a control unit 10, a peripheral assembly 20, a gravity sensor (G-sensor) 30, an electromotive force generating unit 40, a gear transmission unit 50, and a power-assisted unit 60. The control unit 10 is electronically coupled to the peripheral assembly 20, the G-sensor 30, the electromotive force generating unit 40, the gear transmission unit 50, and the power-assisted unit 60.

In at least one embodiment, the gear transmission unit 50 can have a first shift gear, a second shift gear, and a third shift gear adapted to enable multiple speed stages of the bicycle. The first shift gear can indicate that the bicycle rides on a flat road, the second shift gear can indicate that the bicycle rides on an uphill road, and the third shift gear can indicate that the bicycle rides on a downhill road. The power-assisted unit 60 is configured to provide extra power to the bicycle to drive the bicycle.

The peripheral assembly 20 can have a touch panel for inputting control parameters of the speed control apparatus 100. In addition, working state parameters of the speed control apparatus 100 can be displayed on the peripheral assembly 20, the operation state parameters can at least include the speed stages, a slope of the road, and an accumulated mileage. The peripheral assembly 20 further includes a communication unit 22, such as a universal serial bus (USB) port, for example. The speed control apparatus 100 is electronically coupled to a portable electronic device (for example, a mobile phone) via the communication unit 22, and then the portable electronic device can set or reset the control parameters of the speed control apparatus 100. Optionally, the communication unit 22 can also be a BLUETOOTH® module configured to receive the control parameters from the portable electronic device and send the working state parameters of the speed control apparatus 100 to the portable electronic device.

The G-sensor 30 is configured to sense an inclined angle of the bicycle, thereby outputting a control signal indicating the slope of the road to the control unit 10. Thus, the control unit 10 can determine the slope of the road according to the control signal and also determine whether the bicycle riding on the uphill road, the downhill road, or the flat road. In addition, the control unit 10 turns on/off the power-assisted unit 60 and controls the gear transmission unit 50 to shift to the first shift gear, the second shift gear, and the third shift gear, in order to suit the flat road, the uphill road, and the downhill road, respectively.

In at least one embodiment, the electromotive force generating unit 40 is disposed on the pedal of the bicycle. The electromotive force generating unit 40 includes a magnet 42 and a closed loop circuit 44. The closed loop circuit 44 is drove by the pedal of the bicycle to cut magnetic-lines of the magnet 42 and thus produces electromotive force. In other embodiments, the magnet 42 is drove by the pedal of the bicycle to move relative to the closed loop circuit 44. The closed loop circuit 44 is electronically coupled to the control unit 10, so that the control unit 10 can control the power-assisted unit 60 and the gear transmission unit 50 according to a variation of the electromotive force.

In detail, when the bicycle rides on the flat road, the electromotive force produced by the electromotive force generating unit 40 can be substantially unchanged. At this time, the control unit 10 controls the gear transmission unit 50 to shift to the first shift gear and turns off the power-assisted unit 60. When the bicycle rides on the uphill road, the electromotive force produced by the electromotive force generating unit 40 can be less than a threshold. At this time, a rotational velocity of the pedal can be decreased for indicating a force applied to the pedal is insufficient. Thus, the control unit 10 controls the gear transmission unit 50 to shift to the second shift gear and turns on the power-assisted unit 60. When the bicycle rides on the downhill road, the electromotive force produced by the electromotive force generating unit 40 can drop to zero. At this time, the pedal can not rotate. Thus, the control unit 10 controls the gear transmission unit 50 to shift to the third shift gear and turns off the power-assisted unit 60.

In other embodiments, one of the G-sensor 30 and the electromotive force generating unit 40 can be omitted.

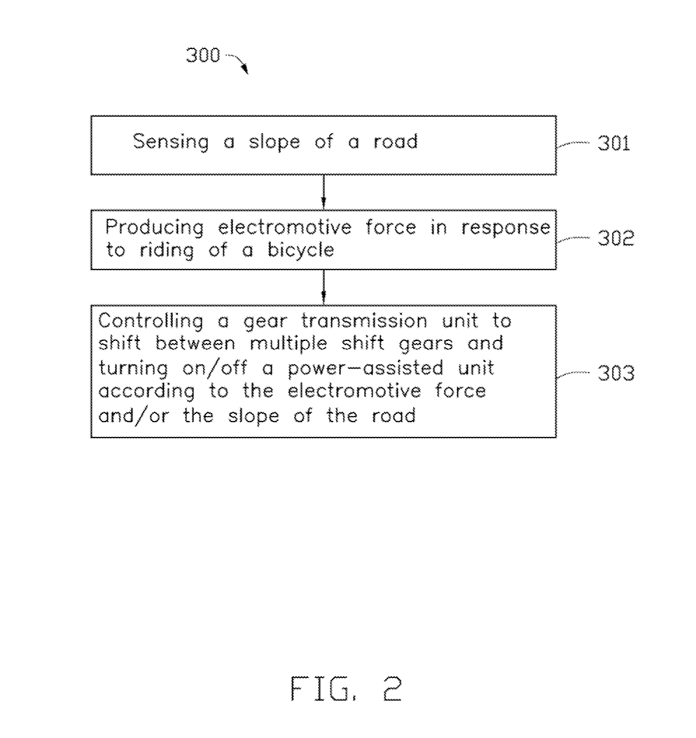

FIG. 2 illustrates a flowchart of an example speed control method 300 of the disclosure. The speed control method 300 is provided by way of example, as there are a variety of ways to carry out the speed control method 300. The speed control method 300 described below can be carried out using the functional units of the speed control apparatus 100 as illustrated in FIG. 1, for example, and various elements of this figure are referenced in explaining the example speed control method 300. Each block shown in FIG. 2 represents one or more processes, methods, or subroutines which are carried out in the example speed control method 300. Furthermore, the order of blocks is illustrative only and the order of the blocks can change. Additional blocks can be added or fewer blocks may be utilized without departing from the scope of this disclosure. The example speed control method 300 can begin at block 301.

At block 301, a G-sensor senses an inclined angle of a bicycle, thereby outputting a control signal indicating a slope of a road to a control unit.

At block 302, an electromotive force generating unit produces electromotive force in response to riding of the bicycle.

At block 303, a control unit controls a power-assisted unit and a gear transmission unit according to a variation of the electromotive force and/or the slope of the road. In detail, when the bicycle rides on a flat road and/or the electromotive force produced by the electromotive force generating unit is substantially unchanged, the control unit controls the gear transmission unit to shift to a first shift gear and turns off the power-assisted unit. When the bicycle rides on an uphill road and/or the electromotive force produced by the electromotive force generating unit is less than a threshold, the control unit controls the gear transmission unit to shift a second shift gear and turns on the power-assisted unit. When the bicycle rides on a downhill road and/or the electromotive force produced by the electromotive force generating unit drops to zero, the control unit controls the gear transmission unit to shift to a third shift gear and turns off the power-assisted unit.

The speed control apparatus 100 includes the control unit 10, the G-sensor 30, and the electromotive force generating unit 40. The G-sensor 30 senses the slope of the road, the electromotive force generating unit 40 produces the electromotive force, and the control unit 10 controls the power-assisted unit 60 and the gear transmission unit 50 to be adapted to enable the multiple speed stages of the bicycle according to the variation of the electromotive force and/or the slope of the road. Thus, the speed control apparatus 100 is both efficient and convenient.

The embodiments shown and described above are only examples. Many details are often found in the art such as the other features of the speed control apparatus and the speed control method for a bicycle. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A speed control apparatus for a bicycle, the speed control apparatus comprising:
a power-assisted unit configured to provide extra power to the bicycle;
at least one of a gravity sensor (G-sensor) and an electromotive force generating unit, the G-sensor configured to sense a slope of a road, and the electromotive force generating unit configured to produce electromotive force in response to riding of the bicycle; and
a control unit electronically coupled to the power-assisted unit, the at least one of the G-sensor and the electromotive force generating unit, the control unit configured to activate or deactivate the power-assisted unit according to the electromotive force or the slope of the road or both.

2. The speed control apparatus as claimed in claim 1, further comprising a gear transmission unit having multiple shift gears adapted to enable multiple speed stages of the bicycle, wherein the control unit is electronically coupled to the gear transmission unit to control the gear transmission unit to shift between the multiple shift gears according to the electromotive force or the slope of the road or both.

3. The speed control apparatus as claimed in claim 1, wherein the electromotive force generating unit comprises a magnet and a closed loop circuit, the closed loop circuit is moved relative to the magnet to produce the electromotive force, the control unit controls the power-assisted unit and the gear transmission unit according to a variation of the electromotive force.

4. The speed control apparatus as claimed in claim 3, wherein the G-sensor senses an inclined angle of the bicycle and outputs a control signal indicating the slope of the road to the control unit, the control unit determines the slope of the road according to the control signal and also determines whether the bicycle riding on a uphill road, a downhill road, or a flat road.

5. The speed control apparatus as claimed in claim 4, wherein when the bicycle rides on the flat road and/or the electromotive force produced by the electromotive force generating unit is substantially unchanged, the control unit controls the gear transmission unit to shift to a first shift gear and turns off the power-assisted unit.

6. The speed control apparatus as claimed in claim 4, wherein when the bicycle rides on the uphill road and/or the electromotive force produced by the electromotive force generating unit is less than a threshold, the control unit controls the gear transmission unit to shift a second shift gear and turns on the power-assisted unit.

7. The speed control apparatus as claimed in claim 4, wherein when the bicycle rides on the downhill road and/or the electromotive force produced by the electromotive force generating unit drops to zero, the control unit controls the gear transmission unit to shift to a third shift gear and turns off the power-assisted unit.

8. The speed control apparatus as claimed in claim 1, further comprising a peripheral assembly, wherein the peripheral assembly is a touch panel for inputting control parameters of the speed control apparatus.

9. The speed control apparatus as claimed in claim 8, wherein the peripheral assembly comprises a communication unit to communicate with a portable electronic device, and the control parameters of the speed control apparatus is set or reset by the portable electronic device.

10. A speed control method for a bicycle, the speed control method comprising:
sensing, by a gravity sensor (G-sensor), a slope of a road;
producing, by an electromotive force generating unit, electromotive force in response to riding of the bicycle; and
activating or deactivating, by a control unit, a power-assisted unit according to the electromotive force or the slope of the road or both.

11. The speed control method as claimed in claim 10, further comprising controlling, by a control unit, a gear transmission unit to shift between multiple shift gears according to the electromotive force or the slope of the road or both.

12. The speed control method as claimed in claim 11, wherein when the bicycle rides on a flat road and/or the electromotive force produced by the electromotive force generating unit is substantially unchanged, the control unit controls the gear transmission unit to shift to a first shift gear and turns off the power-assisted unit.

13. The speed control method as claimed in claim 11, wherein when the bicycle rides on an uphill road and/or the electromotive force produced by the electromotive force generating unit is less than a threshold, the control unit controls the gear transmission unit to shift a second shift gear and turns on the power-assisted unit.

14. The speed control method as claimed in claim 11 wherein when the bicycle rides on a downhill road and/or the electromotive force produced by the electromotive force generating unit drops to zero, the control unit controls the gear transmission unit to shift to a third shift gear and turns off the power-assisted unit.
